(19) United States
(12) Patent Application Publication
(10) Pub. No.: US 2015/0271196 A1
(43) Pub. Date: Sep. 24, 2015

(54) COMPARING SOURCE AND SINK VALUES IN SECURITY ANALYSIS

(71) Applicant: International Business Machines Corporation, Armonk, NY (US)

(72) Inventors: Roee Hay, Haifa (IL); Omer Tripp, Bronx, NY (US)

(73) Assignee: International Business Machines Corporation, Armonk, NY (US)

(21) Appl. No.: 14/220,324

(22) Filed: Mar. 20, 2014

(51) Int. Cl. H04L 29/06; G06F 21/57

(52) U.S. Cl. CPC H04L 63/1433; G06F 21/577; H04L 63/1408

(57) ABSTRACT

Techniques for determining differences between source and sink values are described herein. The techniques may include identifying a data-flow source statement within a computer program, and recording a value read at the source statement. The techniques may include identifying a sink of the data flow, and record a value flowing into the sink. The source value may be compared to the sink value to determine whether a potential security leak exists.

### BACKGROUND

The present invention relates generally to security analysis. More specifically, the techniques described herein include comparing source and sink values to determine security leaks.

### SUMMARY

In one embodiment, a method for comparing source and sink values is described herein. The method may include identifying a data-flow source statement within a computer program, and recording a value read at the source statement. The method may identify a sink of the data flow, and a value flowing into the sink. The source value may be compared to the sink value to determine whether a potential security leak exists.

### BRIEF DESCRIPTION OF DRAWINGS

FIG. 1 is a block diagram of a computing system configured to compare values at a source and a sink;

FIG. 2 is a block diagram of a system for comparing source and sink values;

FIG. 3 is a flowchart illustrating source and sink comparison in issuing security warnings;

FIG. 4 is a block diagram illustrating a method of comparing source and sink values to determine security leaks; and

FIG. 5 is a block diagram depicting an example of a tangible computer readable medium that can be used to compare source and sink values.

### DETAILED DESCRIPTION

The subject matter disclosed herein relates to techniques for comparing source and sink statements to determine security leaks in a data flow. Dynamic security analysis typically assumes the form of taint analysis wherein data is tagged and followed through a data flow to determine potential security breaches. For example, a variable that may be changed by a user, such as in a web-form, poses a potential security risk. In this scenario, the web form variable is tagged and followed through data flow of the web page such that any additional variable set as a result of the tagged variable is also tagged. In some cases, values containing data that are not sanitized in taint analysis may propagate from a source to a sink and a security warning may be issued.

In some scenarios, taint analysis may require the tracking of data flow across an entire data flow of a program. Tracking of data may require overhead and may lead clients to unsoundly remove instrumentation from parts of code of the program performing a given function. In some scenarios, taint analysis may identify false positives wherein statements are identified as having a security breach due to a tag being identified in the sink statement, even when the tagged data does not reveal sensitive information.

In the embodiments described herein, source and sink statements may be identified, and their respective values recorded and compared to determine whether a security leak has occurred. A source statement, as referred to herein, may include a statement receiving reading sensitive data, such as user-provided data. A source value may be the data read by the source statement. A sink statement, as referred to herein, may include a statement of a computing program receiving data flow. The data flow read at the sink statement may be referred to herein as a sink value. As discussed in more detail below, when the source and sink value are sufficiently similar, the likelihood that a security leak exists is higher, than if the values are dissimilar.

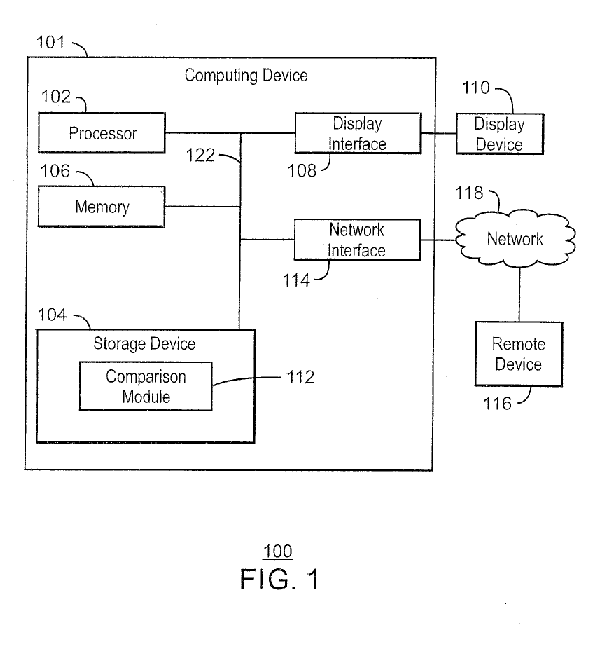

FIG. 1 is a block diagram of a computing system configured to compare source and sink values. The computing system 100 may include a computing device 101 having a processor 102, a storage device 104 comprising a computer readable storage medium, a memory device 106, a display interface 108 communicatively coupled to a display device 110. The computing device 101 may include a network interface 114 communicatively coupled to a remote device 116 via a network 118. The storage device 104 may include a comparison module 112 configured to compare source and sink values. In embodiments, comparison module 112 may be used by a web crawler (not shown) to determine source and sink values of a given webpage hosted on remote device 116. In some embodiments, display interface 108 may enable a user of computing system 101 to view the comparison between source and sink values. Display device 110 may be an external component to computing device 101, an integrated component of computing device 101, or any combination thereof.

Comparison module 112 may be logic, at least partially comprising hardware logic. In embodiments, graph module 112 may be implemented as instructions executable by a processing device, such as processor 102. The instructions may direct processor 102 to identify a data-flow source statement within a computer program, and record a value read at the source statement. The instructions may direct processor 102 to identify a sink of the data flow, and record a value flowing into the sink. As discussed in more detail below, when source and sink values are recorded, comparison module 112 may compare the source value to the sink value to determine whether a potential security leak exists.

Processor 102 may be a main processor that is adapted to execute the stored instructions. Processor 102 may be a single core processor, a multi-core processor, a computing cluster, or any number of other configurations. Memory unit 106 can include random access memory, read only memory, flash memory, or any other suitable memory systems. The main processor 102 may be connected through a system bus 122 to components including memory 106, storage device 104, and display interface 108.

The block diagram of FIG. 1 is not intended to indicate that computing device 101 is to include all of the components shown in FIG. 1. Further, computing device 101 may include any number of additional components not shown in FIG. 1, depending on the details of the specific implementation.

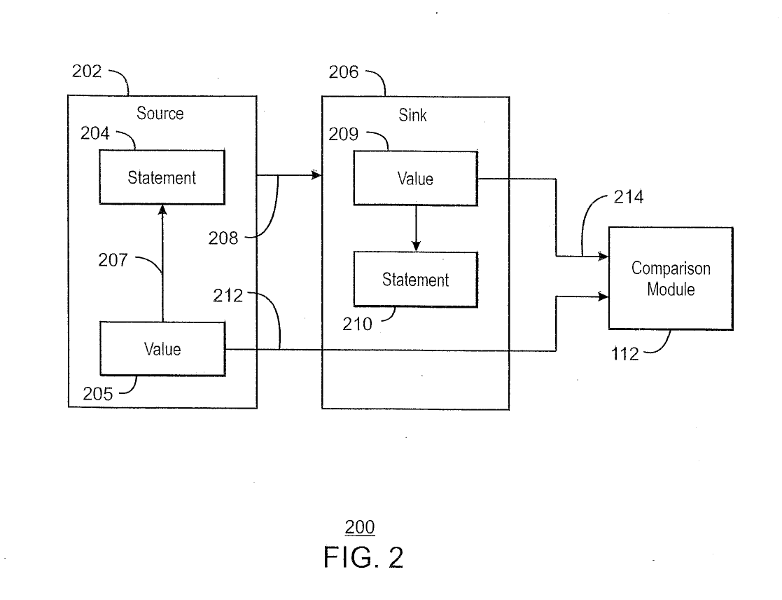

FIG. 2 is a block diagram of a system 200 for comparing source and sink values. As illustrated in FIG. 2, a computing program may be analyzed to compare values at a source and a sink. The computing program may include a source 202 having a statement 204 configured to read a source value 205, as indicated by arrow 207. For example, source statement 204 may read a value, such as a device identification (ID) number of a mobile device. Source statement 204 may be a computer-implemented request to read the device ID, and therefore may include the device ID. In this scenario, the device ID is the source value. As a result of the computer-program reading source value 205, a sink 206 may receive a data-flow as indicated by arrow 208. A sink value 209 flowing into a sink statement 210 may be captured and compared at the comparison module as indicated by arrows 212 and 214.

In the example above, a device ID may include 16 characters. Operations performed by the computer program under analysis may provide at least some of the 16 characters to sink 206. However, a computer program instrumented to provide all 16 characters of the device ID to sink 206 may represent a security risk. Therefore, in this scenario, source value 205 is compared to sink value 209 to determine whether the values are substantially similar.

Comparison module 112 may record the source and sink values, 204, 210, as indicated by arrows 212 and 214, and compare the values. In this embodiment, overhead required by taint analysis is reduced as data flow is not tracked from source to sink, but values at source 202 and sink 206 are recorded and compared.

In some embodiments, values 205, 209, are compared based on a string metric. A string metric is a function configured to measure the similarity or dissimilarity between two strings. The comparison of similarity may be based on a threshold. For example, if the device ID is a 16 character string at source value 205, and contains 14 of the 16 characters at the sink value 209, a similarity of 87.5% (14/16) is determined. In an example scenario, the threshold may be set at 50%, wherein similarities are based on ratios of the source value characters to the sink value characters. In this scenario, a security warning may be issued as the similarity of 87.5% is above the threshold.

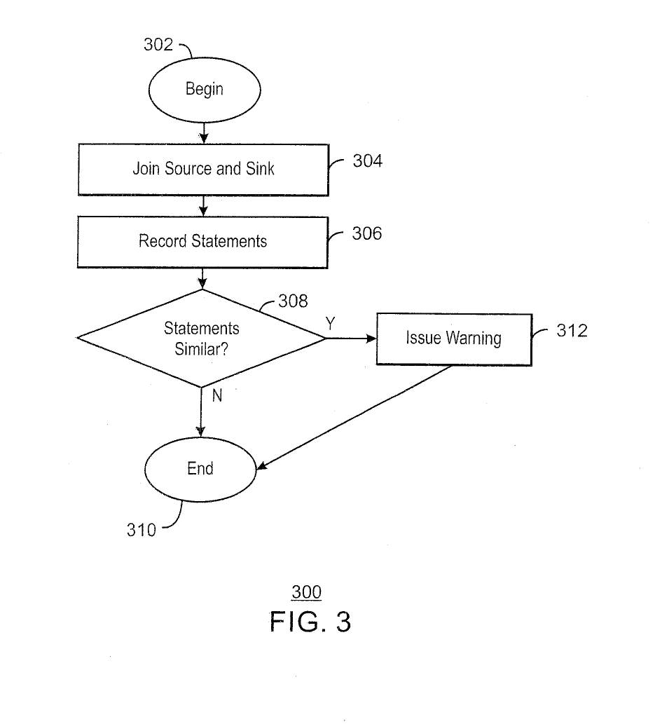

FIG. 3 is a flowchart illustrating source and sink comparison in issuing security warnings. At 302, comparison process 300 may begin. At 304, a target application is instrumented such that entry into all methods in the union of source and sink triggers an event. During execution, if an event is received for a source method, then a return value for the source method is recorded as the source value, as indicated by 306. Similarly, if an event is received for a sink method, then a return value for the sink method is recorded as the sink value, also indicated by 306. At 308, the statements may be compared to determine whether the values are similar. As discussed above, the source and sink values may be compared based on a similarity threshold. If the source and sink values are similar, then a security warning is used at 312, and if not, then the process 300 ends at 310.

In embodiments, comparison process 300 may include additional steps. In one scenario, a sink value may be evaluated to determine whether a potentially malicious statement exists within the sink value. For example, a comparison may determine that the similarity between the source and the sink values is below the threshold, but that the sink value includes potentially malicious language such as cross-site scripting language. In a cross-site scripting attack, a source value may read the value of a user-provided hyper-text transfer protocol (HTTP) parameter and the sink statement may render a value of the parameter to a resulting hypertext markup language (HTML) page. In this scenario, the sink value may be evaluated to determine whether the sink value includes any cross-site scripting.

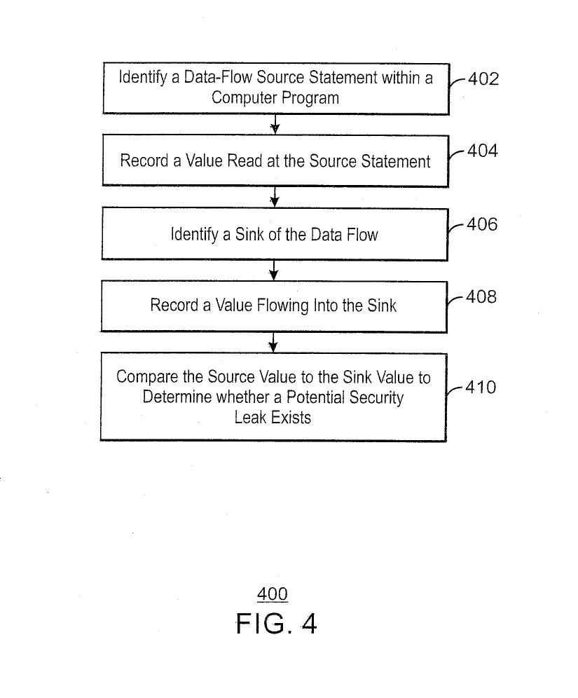

FIG. 4 is a block diagram illustrating a method of comparing source and sink values to determine security leaks. As illustrated in FIG. 4, the method 400 may identify a data-flow source statement within a computer program at 402, and may record a value read at the source statement at 404. A sink of the data flow may be identified at 406 and a value flowing into the sink may be recorded at 408. As block 410, the source and sink values may be compared to determine whether a potential security leak exists.

As discussed above, the comparison may be based on a string metric identifying similarity between strings in a source and sink values. In embodiments, the similarity determination may be based on a threshold, wherein the string metric may identify a similarity value, and wherein similarity values above the threshold are identified as being substantially similar.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

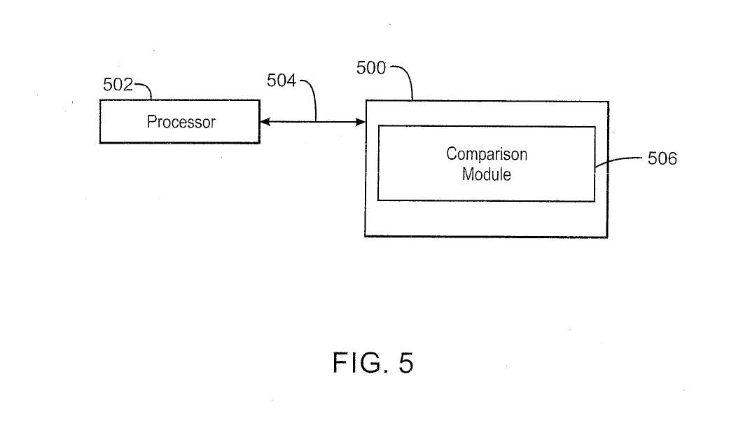

FIG. 5 is a block diagram depicting an example of a tangible computer readable storage medium that can be used to compare source and sink statements. The tangible computer readable storage medium 500 may be accessed by a processor 502 over a computer bus 504. Furthermore, the tangible computer readable storage medium 500 may include computer-executable instructions to direct the processor 502 to perform the steps of the current method.

The various software components discussed herein may be stored on the tangible computer readable storage medium 500, as indicated in FIG. 5. For example, a comparison module 506 may be configured to identify a data-flow source statement within a computer program, and record a value read at the source statement. The comparison module 506 may be configured to identify a sink of the data flow, and record a value flowing into the sink. When source and sink values are recorded, the comparison module 506 may compare the source value to the sink statement to determine whether a potential security leak exists.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1-7. (canceled)

8. A computing device, comprising:
one or more computer processors;
one or more computer readable storage media; and
program instructions stored on at least one of the one or more computer readable storage media for execution by at least one of the one or more processors, the program instructions comprising:
program instructions to identify a data-flow source statement within a computer program;
program instructions to record a value read at the source statement;
program instructions to identify a sink of the data flow;
program instructions to record a value flowing into the sink; and
program instructions to compare the source value to the sink value to determine whether a potential security leak exists.

9. The computing device of claim 8, further comprising program instructions, stored on at least one of the one or more computer readable storage media for execution by at least one of the one or more processors, to:
cause the computing device to determine a threshold related to similarity of the source and the sink values; and
responsive to determining that the source value and the sink value meet or exceed the similarity threshold, issue a security warning.

10. The computing device of claim 8, further comprising program instructions, stored on at least one of the one or more computer readable storage media for execution by at least one of the one or more processors, to cause the computing device to evaluate the sink value to determine whether a potentially malicious value exists.

11. The computing device of claim 10, further comprising program instructions, stored on at least one of the one or more computer readable storage media for execution by at least one of the one or more processors, to cause the computing device to issue a security warning if a potentially threatening value flows into the sink.

12. The computing device of claim 10, wherein the potentially malicious value is related to cross-site scripting, wherein the source statement reads the value as a user-provided hypertext transfer protocol (HTTP) parameter and a sink statement rendering a value of the parameter to a response hypertext markup language (HTML) page.

13. The computing device of claim 8, wherein a device identification (ID) is read as the source value and is recorded.

14. The computing device of claim 8, wherein the comparison is performed using a string metric to measure similarity between the source value and the sink value.

15. A computer program product for security analysis, the computer product comprising a computer readable storage medium having program code embodied therewith, the program code executable by a processor to perform a method, comprising:
identifying a data-flow source statement within a computer program;
recording a value read at the source statement;
identifying a sink of the data flow;
recording a value flowing into the sink; and
comparing the source value to the sink value to determine whether a potential security leak exists.

16. The computer program product of claim 15, the method further comprising:
determining, by one or more computer processors, a threshold related to similarity of the source and the sink values; and
responsive to determining that the source value and the sink value meet or exceed the similarity threshold, issuing a security warning.

17. The computer program product of claim 15, the method further comprising evaluating the sink value to determine whether a potentially malicious value exists.

18. The computer program product of claim 17, the method further comprising issuing a security warning if a potentially threatening value flows into the sink.

19. The computer program product of claim 17, wherein the potentially malicious value is related to cross-site scripting, wherein the source statement reads the value as a user-provided hypertext transfer protocol (HTTP) parameter and a sink statement rendering a value of the parameter to a response hypertext markup language (HTML) page.

20. The computer program product of claim 15, wherein the comparison is performed using a string metric to measure similarity between the source value and the sink value.
